(19) United States
(12) Patent Application Publication
(10) Pub. No.: US 2025/0006016 A1
(43) Pub. Date: Jan. 2, 2025

(54) PAYMENT MECHANICS OF FORMAL GAMES OF CHANCE IN CONSUMER VIDEO GAMES WITH ASSOCIATED TECHNOLOGIES

(71) Applicant: IGT, Las Vegas, NV (US)

(72) Inventors: Stefan Keilwert, St. Josef (AT); Michael Russ, Graz (AT); Sven Aurich, Schwanberg (AT); David Small, Moncton (CA); Soheil Latifi, Moncton (CA)

(21) Appl. No.: 18/215,279

(22) Filed: Jun. 28, 2023

(51) Int. Cl. G07F 17/32

(52) U.S. Cl. CPC G07F 17/3295; G07F 17/3244

(57) ABSTRACT

Embodiments of the present disclosure are directed to providing a game of chance within a skills-based video game. While game of chance features are prohibited in skills-based games in many jurisdictions, there is an opportunity for wagering game publishers, who hold licenses for such games as well as the entire server infrastructure of decentralized certified random number generators, associated with decades of experience with designing such games. The opportunity would be in the form of partnerships between video game publishers and wagering game publishers to bring back loot box-like, in-game wagering mechanisms. Generally speaking, and as will be described in greater detail below, this can be accomplished using the systems and services of the video game publishers to support skills-based aspects of the games while using the systems and services of the wagering game publishers to support the game of chance aspects of the game.

### BACKGROUND

The present disclosure is generally directed to conducting an electronic game and, in particular, toward providing a game of chance within a skills-based video game.

Video game publishers tried to implement loot box elements, paid with real money, into skill-based games. However, those have been abandoned from video games due to certain legal requirements which required the publishers to entirely remove such game of chance-like elements or find mitigated ways around them, e.g., such as wagering free in-game currency only. Hence, there is a need in the art for methods and systems of implementing games of chance or game of chance-like features within video or other skills-based games.

### BRIEF SUMMARY

In certain embodiments, the present disclosure relates to providing a game of chance within a skills-based video game. According to one embodiment, a method for conducting an electronic game can comprise executing a skills-based electronic game and presenting a game of chance while executing the skills-based electronic game. For example, the skills-based electronic game can comprise a character controlled by a player of the skills-based electronic game and presenting the game of chance can be performed in response to the character entering a virtual casino. In some cases, the game of chance can comprise a game conducted against other real or virtual players in the virtual casino. Presenting the game of chance can, in some cases, be performed based on a result in the skills-based electronic game.

The non-wagering session of the game of chance can be conducted during skills-based game. In some cases, the non-wagering session of the game of chance can be provided as an option in a tutorial on the game of chance. In such cases, conducting the non-wagering session of the game of chance can be performed in response to receiving an input indicating selection of the option.

A result of the non-wager session of the game of chance can be determined. Determining the result of the non-wagering session of the game of chance can be based on a random number received by the gaming system from a decentralized random number generator of a certified random number generator infrastructure. In some cases, the result of the non-wagering session of the game of chance can affect the skills-based game of chance. An indication of the determined result of the non-wagering session of the game of chance can be provided in the skills-based game.

According to another embodiment, a gaming system can comprise a processor and a memory coupled with and readable by the processor. The memory can store therein a set of instructions which, when executed by the processor, causes the processor to execute a skills-based electronic game and present a game of chance while executing the skills-based electronic game. Presenting the game of chance can be performed based on a result in the skills-based electronic game.

The instructions can further cause the processor to conduct the session of the game of chance in the skills-based game. Conducting the session of the game of chance during the game of chance can comprise receiving a wager on the game of chance. In some cases, the wager can be made using an in-game asset of the skills-based electronic game. For example, the in-game asset of the skills-based electronic game can comprise a loot box.

The instructions can further cause the processor to receive a random number from a decentralized random number generator of a certified random number generator infrastructure. The random number can be generated by the decentralized random number generator in real-time during the session of the game of chance. The instructions can further cause the processor to determine a result of the session of the game of chance based on the received random number and provide an indication of the determined result of the non-wagering session of the game of chance in the skills-based game. The result of the session of the game of chance can comprise a result in the skills-based electronic game.

According to yet another embodiment, a non-transitory, computer-readable medium can comprise a set of instructions stored therein which, when executed by a processor, causes the processor to execute a skills-based electronic game and present a game of chance while executing the skills-based electronic game. The game of chance comprises slots, video poker, or another casino game. The session of the game of chance can comprise a non-wagering session or a wagering session.

The instructions can further cause the processor to conduct the session of the game of chance in the skills-based game. In some cases, conducting the session of the game of chance can comprise receiving a wager on the game of chance. In some cases, the wager can be made using an in-game asset of the skills-based electronic game and/or a result of the game of chance can affect the in-game asset of the skills-based electronic game. The instructions can further cause the processor to determine a result of the session of the game of chance based on random number received from a decentralized random number generator of a certified random number generator infrastructure in real time during the session of the game of chance and provide an indication of the determined result of the non-wagering session of the game of chance in the skills-based game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure may be implemented.

FIG. 2 is a block diagram illustrating additional details of components of an exemplary gaming system according to one embodiment of the present disclosure.

FIG. 3 is a block diagram illustrating additional details of components of an exemplary gaming host according to one embodiment of the present disclosure.

FIG. 4 is a block diagram illustrating additional details of components of an exemplary gambling host according to one embodiment of the present disclosure.

FIG. 5 is a flowchart illustrating an exemplary process for conducting an electronic game according to one embodiment of the present disclosure.

FIG. 6 is a flowchart illustrating an exemplary process for conducting an electronic game according to another embodiment of the present disclosure.

### DETAILED DESCRIPTION

Embodiments of the present disclosure are directed to providing a game of chance within a skills-based video game. While game of chance features are prohibited in skills-based games in many jurisdictions, there is an opportunity for wagering game publishers, who hold licenses for such games as well as the entire server infrastructure of decentralized certified random number generators, associated with decades of experience with designing such games. The opportunity would be in the form of partnerships between video game publishers and wagering game publishers to bring back loot box-like, in-game wagering mechanisms. Generally speaking, and as will be described in greater detail below, this can be accomplished using the systems and services of the video game publishers to support skills-based aspects of the games while using the systems and services of the wagering game publishers to support the game of chance aspects of the game.

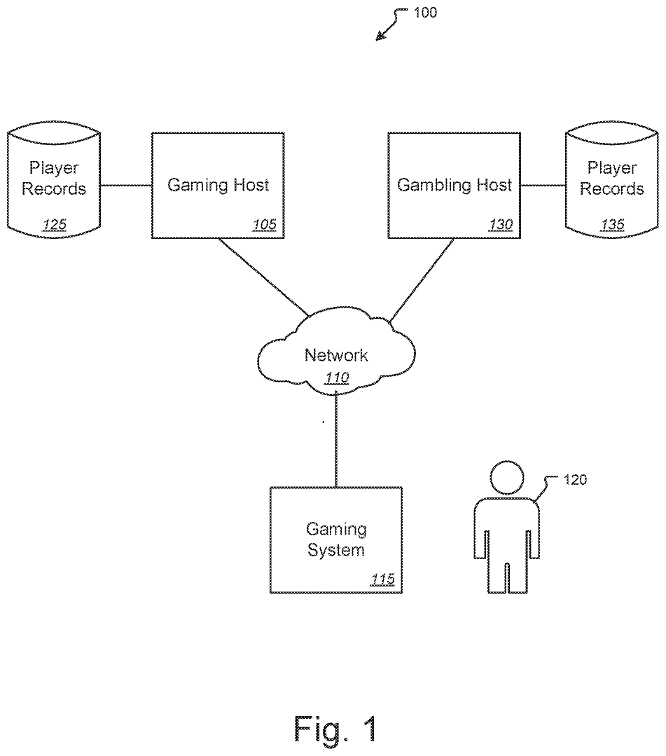

FIG. 1 is a block diagram illustrating an exemplary environment in which embodiments of the present disclosure may be implemented. As illustrated in this example, the environment 100 can comprise a gaming host 105 communicatively coupled with a communications network 110. The gaming host 105 can comprise any one or more servers and/or other computing devices. The communications network 110 can comprise any one or more wired and/or wireless, local-area and/or wide-area networks including but not limited to the Internet. Also coupled with the communications network 110 can be a gaming system 115. The gaming system 115 can comprise, for example, a game console, personal computer, or other computing device executing a video game or other skills-based game. Generally speaking, and as known in the art, the gaming host 105 can monitor and manage execution of the skills-based game on the gaming system 115 and provide services related to play of the skills-based game such as remote play between any number of players. The gaming system 105 can maintain a set of player records 125 for players registered with and known to the gaming host 105. These records 125 can include, but are not limited to, player identity information, payment information, etc.

The environment 100 can further comprise a gambling host 130. The gambling host 130 can comprise any number of servers and/or other computing devices as may be used to support operation of a casino or other gaming venue. Among other things, the gambling host 130 can provide or be part of a distributed, certified random number generator infrastructure as known in the art and used to support, for example, video lottery terminals and other games of chance that utilize random numbers. The gambling host 130 can also maintain a set of player records 135 for player known to the casino of gaming venue. These records can include, but are not limited to, player loyalty account information, casino wallet and/or other payment information, etc.

According to one embodiment, the gambling system 130 can support execution of a game of chance within a skills-based game executed on the gaming system 115. Generally speaking, and as will be described further below, while a skills-based electronic game is executing on the gaming system 115, a game of chance can be presented on the gaming system 115. In some cases, a tutorial can be presented which provides an explanation of the game of chance and a session of the game of chance. The session of the game of chance can be conducted on the gaming system 115 in the skills-based game. According to one embodiment, a result of the game of chance can be determined based on a random number generated or provided by the gambling host 130.

According to one embodiment, the gaming system 115 and/or gaming host 105 can connect to a certified random number generator infrastructure of the gambling host 130 through an Application Program Interface (API). Such an interface can support wired or wireless data exchange via the Internet or other protocols. For example, the gaming system 115 executing the skills-based came can request a random number from the certified random number generator infrastructure via a command through the API, and receive it via the interface for use in the skills-based game where it can be used to determine the results of the game of chance. In some cases, communication via such an API can be secured and encrypted through technologies like Secure Sockets Layer (SSL), Transport Layer Security (TLS), etc. The random number can be generated by the certified random number generator infrastructure in real-time, or, as a series of results in response to requests by the gaming system 115. The skill-based game could then use one transmitted random number or draw from the pool of sent random numbers. Alternatively, the outcome of an in-game event can be predetermined, e.g., requested by the gaming system 115 previously, so that in the moment of presenting the outcome to the player the results are available, just not shown to the player, e.g., similar to scratch tickets. According to various embodiments, the certified random number generator infrastructure can be configured to draw a number from a given range, e.g. 0-10, can be configured to draw a binary outcome, e.g., true/false, can be configured to draw a series of random numbers and return it to the requester, can be configured to create a pool of random numbers and draw from the pool, i.e., with or without putting back drawn numbers, can be reset, can be configure to draw numbers continuously, at the moment a request is received the current number is returned, can be controlled and configured via an API remotely by the skills-based game server, and others.

According to one embodiment, the gaming host 105 can be co-located with the gambling host 130 providing the decentralized random number generator. Alternatively, if that is not the case, the gaming host 105 and gambling host 130 can communicate via network technologies (wired, wireless). Gaming host 105 can, in some cases, run a certified random number generator and skills-based game support at the same time as two independent programs. In such cases, the certified random number generator can be embedded into the software of the gaming host 105, given it is located in a certified jurisdiction.

According to one embodiment, the session of the game of chance can be a non-paid, free session. These can be provided so that the player 120 becomes more familiar with games of chance, through the video game they like, which can encourage the player to visit a casino or other gaming venue where the game of chance is available. Such games could be entirely free, played without any limits, and just for fun. In other cases, they could require some in-game currency earned for free as player progresses in the skills-based game.

For example, the player 120 of the skills-based game may accumulate experience points or similar which can be collected to level up. Such points could be wagered within the game of chance to either increase or decrease their level progress depending upon the result of the game of chance. Similarly, the skills-based game could include a non-paid loot box which accumulates value and which can be used to make wagers on the game of chance but which cannot be exchanged to real money in any way.

In some cases, the game of chance can include “earning achievements” for the skills-based game. For example, if the player achieved certain milestones in the game of chance, e.g., enter the slot game bonus, a feature or function of the skills-based game could be unlocked. Such achievements could be optional or could be a prerequisite for making progress in the skills-based game's story. Additionally, or alternatively, the game of chance can be provided as a bonus reward of the skills-based game.

In some cases, the skills-based game can include a character controlled by the player 120, such as an open world game. In such cases, the game of chance could be launched when the player 120 navigates the character into a virtual casino that is part of the environment in the skills-based game. A game of chance session can then be conducted between the player and the casino, between the player and other players, or mixes of both. In some cases, a character controlled by a player of the skills-based game can play against a non-player-character, e.g., a bot. The non-player-character's actions/responses can be derived from the random number outcome. For example, if a skill-based game had presented therein a card game and a player decides to play against a non-player-character, then the outcome could be drawn from the decentralized random number generator, i.e., the gambling host 130 of the certified random number generator infrastructure. The games played in such manner can include any virtual casino games, and all kinds of casino games known from the real world including, but not limited to, slots, poker, roulette, scratch tickets, all kinds of card games, in-game betting on the outcome of in-game events, etc.

According to one embodiment, the game of chance can comprise a paid game in which wagers are made using real money. In some cases, the player may be required to achieve certain thresholds in free games of chance first, until they are unlocked to play the paid version of the game, as part of the skills-based game. In other cases, “Welcome bonus credits” can be provided for getting started with the paid game version, e.g., 30$ as real money non-refundable welcome bonus. Additionally, or alternatively, the paid game of chance could be purchased using an in-game currency bought for real money.

Real money can be transferred from the real world into the game in a variety of ways. For example, a wager can be made on the game of chance with real money transferred into the game, via PayPal, credit card, or other means. In other cases, in-game currency can be bought using such methods and wagers can be made on the game of chance using the in-game currency within the skills-based game. In yet another example, wagers could be placed on the game of chance using an account of the gaming host, e.g., a Stream account when playing a skills-based game in Steam. Similarly, real money can be transferred from the game into the real world in a variety of different ways. For example, the player may be able to accumulate real money, credits, in-game currency, etc. in the game, as indicated in player records 125, and be able to transfer these funds to a bank account.

According to one embodiment, in-game credits or currencies can be accumulated in a loot box. In some cases, the loot box can be limited in the time, e.g., just today, number, e.g., only 5000 pc, or prize, e.g., 20% discount. According to one embodiment, the gaming system 115 may execute a loot box manager application that presents information about the bought boxes and the benefit. In some cases, this application can present information about missing loot boxes and where and when in the environment of the skills-based game they can be bought or found.

According to one embodiment, if a player cannot afford an in-game feature, they could gamble for it. In such cases, the wager amount can be lower than the cost of the feature and the players could play the game of chance to win the feature. In other cases, winnings from the game of chance could be redeemable toys and prizes from third parties, i.e., other than the operators of the gaming host 105 and gambling host 130. In some cases, players may be able to redeem some gifts only via gambling, redirecting the focus of the players.

According to one embodiment, player can own a unique in-game wallet that is tied to the skill-based game's player account. In such cases, an in-game wager can be taken from and credited to the player's wallet in currency, in-game currency, tokens, etc. The wallet can be managed through the skills-based game by the gaming host 105, for example. Depending on jurisdictional requirements the repository storing records of player wallets can reside in the same geographical location as the gambling host 130 or other element of the certified random number generator. Various kinds of monetary in-game rewards can be triggered by or dependent on number outcomes mimicking concepts such as jackpots, mystery pays, collect X items to get a Y reward where either or both of X and/or Y are determined based on a random number.

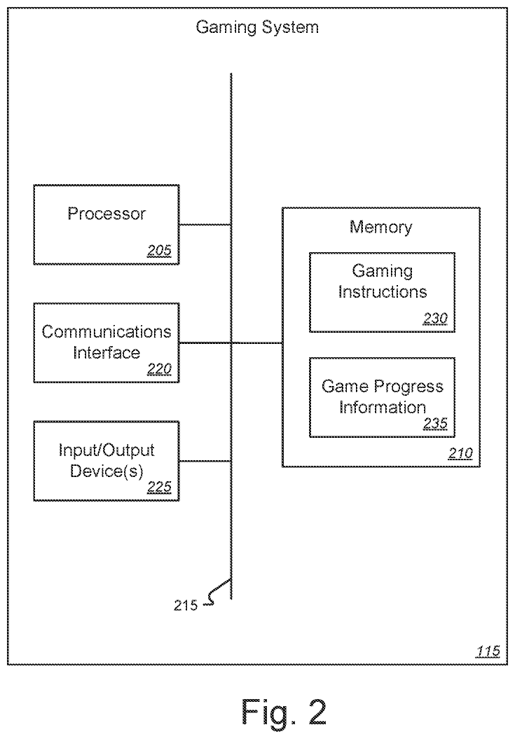

FIG. 2 is a block diagram illustrating additional details of components of an exemplary gaming system according to one embodiment of the present disclosure. As illustrated in this example, a gaming system 115 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming system 115 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interfaces 220 and one or more input/output devices 225 via the communications bus 215. The communication interfaces 215 can comprise, for example, a Bluetooth, WiFi, cellular, and/or other type of wireless communications interface. The input/output devices can include, but are not limited to a display device such as a Liquid Crystal Display (LCD), Light Emitting Diode (LED), Organic Light Emitting Diode (OLED), or other type of display.

The memory 210 can store therein a set of gaming instructions 230 which, when executed by the processor 205, cause the processor 205 to execute a skills-based electronic game and provide a player ID for a player 120 of the skills-based game to a gambling host 130. The gambling host 130 can use the player ID to look up a player record 135 for the player 120 maintained by the gambling host 130. In some cases, the gambling host can also verify the player 120, e.g., perform an age verification.

The gaming instructions 230 can further cause the processor to present the game of chance while executing the skills-based electronic game and conduct a session of the game of chance in the skills-based game. Presenting the game of chance can be performed based on a result or action in the skills-based electronic game indicated by game progress information 235 maintained in the memory 210 of the gaming system 115. Conducting the session of the game of chance can comprise requesting a random number from the gambling host 130. The gaming instructions 230 can further cause the processor 205 to receive the random number from the gambling host 130, determine a result of the session of the game of chance based on the random number and provide an indication of the determined result in the presented tutorial on the game of chance.

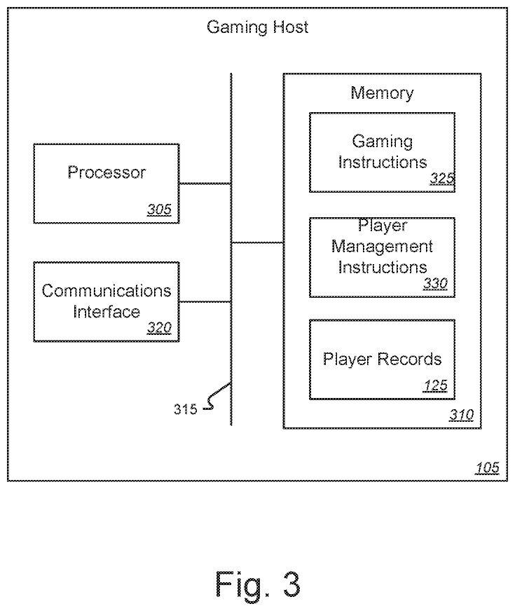

FIG. 3 is a block diagram illustrating additional details of components of an exemplary gaming host according to one embodiment of the present disclosure. As illustrated in this example, the gaming host 105 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320 via the communications bus 315. The communication interfaces 320 can comprise, for example, Ethernet, Bluetooth, WiFi, or other type of wired or wireless communications interfaces.

The memory 310 can store therein a set of gaming instructions 225 which, when executed by the processor 205, cause the processor 205 to monitor and manage skills-based game execution by the gaming system 115 as known in the art. The memory 310 can also have stored therein a set of player management instructions 330 which, when executed by the processor 305, cause the processor 305 to receive, via the communications interface 320, a player ID from the gaming system 115, and identify the player 120 of the gaming system 115 based on the player ID, and verify the player 120, e.g., perform age verification based on player records 125 maintained in the memory 310 of the gaming host 105, and based on the verification, enable 525 a game of chance on the gaming system 115. The player management instructions 230 can further cause the processor 305 to provide, via the communications interface 320, an indication to the gaming system 115 that the game of chance is enabled for the player, e.g., based on the verification, receive from the gaming system 115, via the communications interface 320, a result of the game of chance conducted on the gaming system 115, and update the player record 125 for the player 120, e.g., to persist the result, credit the player for a win, etc.

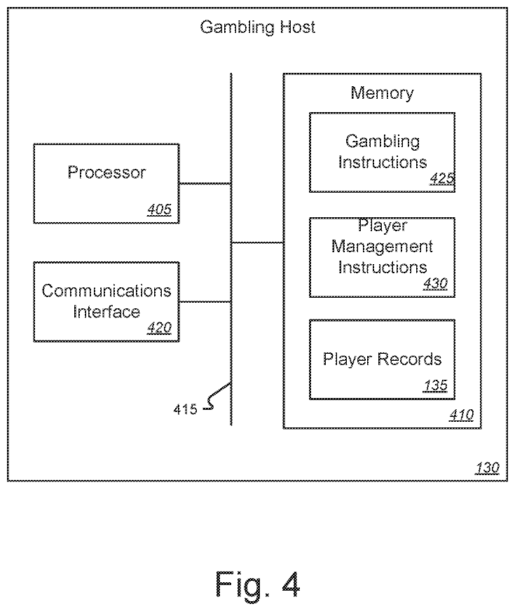

FIG. 4 is a block diagram illustrating additional details of components of an exemplary gambling host according to one embodiment of the present disclosure. As illustrated in this example, the gambling host 130 can comprise a processor 405 such as any of the various types of processors described above. A memory 410 can be coupled with and readable by the processor 405 via a communications bus 415. The memory 410 can comprise any one or more of the different types of volatile and/or non-volatile memories described above. The processor 405 can also be coupled with one or more communication interfaces 420 via the communications bus 415. The communication interfaces 420 can comprise, for example, Ethernet, Bluetooth, WiFi, or other type of wired or wireless communications interfaces.

The memory 410 can store therein a set of player management instructions 430 which, when executed by the processor 405, causes the processor 405 to receive a player ID for a player 120 of the gaming system 115 and identify the player 120 based on the player ID. For example, the player management instructions 430 can cause the processor 405 to use the player ID to look up a player record 135 for the player 120 maintained in the memory 410 the gambling host 130.

The memory 410 can store therein a set of random number generator instructions 425 which, when executed by the processor 405, causes the processor 405 to receive, via the communications interface 420, a request for a random number from the gaming system, e.g., when the game of chance is being conducted on the gaming system 115, generate the random number, and provide the random number to the gaming system 115 via the communications interface. The player management instructions 430 can further cause the processor 405 to receive a result of the game of chance from the gaming system 115 via the communications interface 420 and update the player record 135 for the player 120, e.g., to persist the result, credit the player for a win, etc.

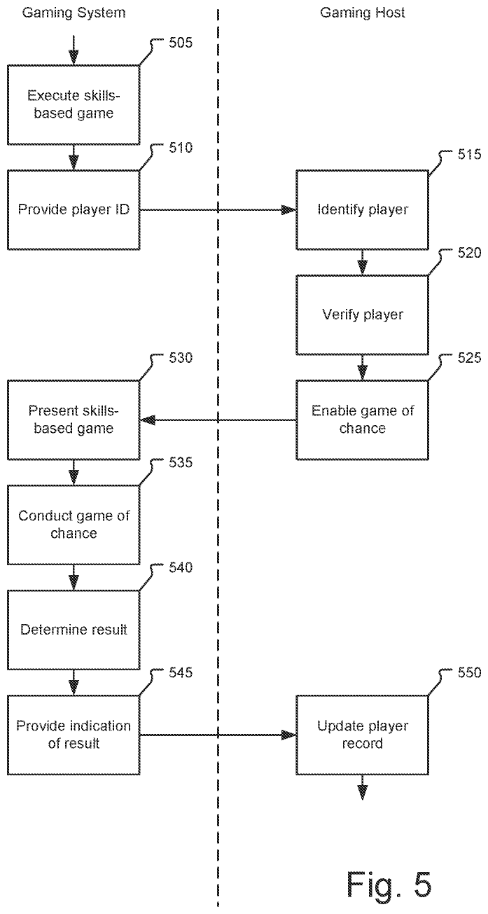

FIG. 5 is a flowchart illustrating an exemplary process for conducting an electronic game according to one embodiment of the present disclosure. As illustrated in this example, conducting an electronic game can comprise executing 505, on a gaming system 115, a skills-based electronic game. According to one embodiment, a player ID for a player of the skills-based game can be provided 510 to a gaming host 105. The gaming host 105 can receive the player ID and identify 515 the player based on the player ID. In some cases, the gaming host 105 can also verify 520, e.g., perform age verification based on player records 125 maintained by the gaming host 105, and based on the verification, enable 525 a game of chance on the gaming system 115.

In response to the gaming host enabling 525 the game of chance, the gaming system 115 can present 530 the game of chance while executing the skills-based electronic game. In some cases, a tutorial can be present which provides an explanation of the game of chance and a session of the game of chance. The game of chance can comprise video slots, video poker, or another casino game. In some cases, the game of chance can comprise a game conducted against other real and/or virtual players in the virtual casino. Presenting 530 the game of chance can be performed based on a result or action in the skills-based electronic game. For example, the skills-based electronic game can comprise a character controlled by a player of the skills-based electronic game and presenting 530 the game of chance can be performed in response to the character entering a virtual casino.

The session of the game of chance can be conducted 535 on the gaming system 115 in the skills-based game. In some cases, the session of the game of chance can be provided as an option and conducting 535 the session of the game of chance can be performed in response to receiving an input indicating selection of the option. The session of the game of chance can comprise a non-wagering session or a wagering session in which the player of the skills-based game can make a wager on the game of chance. In such cases, conducting the session of the game of chance during the game of chance can comprise receiving a wager on the game of chance. The wager can be made using real money, e.g., paid from a credit card, player account, etc., or an in-game asset of the skills-based electronic game. For example, the in-game asset of the skills-based electronic game can comprise a loot box.

A result of the session of the game of chance can be determined 540 by the gaming system 115 and an indication of the determined result of the session of the game of chance can be provided 545 by the gaming system 115 in the skills-based game. In some cases, the result of the session of the game of chance can affect the skills-based game of chance. For example, a result of the session of the game of chance can comprise a result in the skills-based electronic game. Additionally, or alternatively, the result can be provided to the gaming host and the player record 125 for the player 120 can be updated 550, e.g., to persist the result, credit the player for a win, etc.

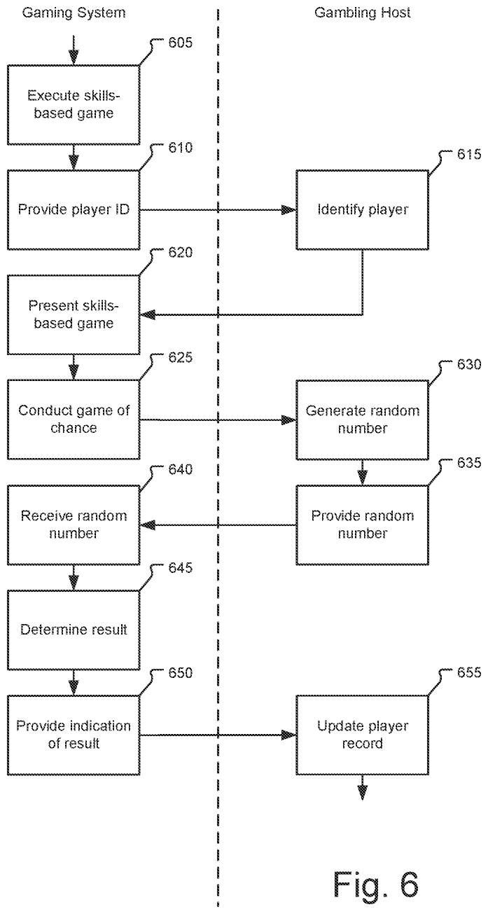

FIG. 6 is a flowchart illustrating an exemplary process for conducting an electronic game according to another embodiment of the present disclosure. As illustrated in this example, conducting an electronic game can comprise executing 605, on a gaming system 115, a skills-based electronic game and providing 610 a player ID for a player 120 of the skills-based game to a gambling host 130. The gambling host 130 can receive the player ID and identify 615 the player based on the player ID. For example, the gambling host 130 can use the player ID to look up a player record 135 for the player 120 maintained by the gambling host 130.

The gaming system 115 can present 620 the game of chance while executing the skills-based electronic game. As noted above, presenting 620 the game of chance can be performed based on a result or action in the skills-based electronic game. The session of the game of chance can be conducted 625 on the gaming system 115 in the skills-based game. Conducting 625 the session of the game of chance can comprise requesting a random number from the gambling host 130. The gambling host 130 can in turn generate 630 the random number or obtain the random number from another server of a distributed random number generator of a certified random number generator infrastructure and provide 635 the random number to the gaming system 115.

The gaming system 115 can then receive 640 the random number from the gambling host 130 and determine 645 a result of the session of the game of chance based on the random number and provide 650 an indication of the determined result in the skills-based game. Additionally, or alternatively, the result can be provided to the gambling host 130 and the player record 135 for the player 120 can be updated 655, e.g., to persist the result, credit the player for a win, etc.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for conducting an electronic game, the method comprising:
executing, on a gaming system, a skills-based electronic game;
presenting, on the gaming system, a game of chance while executing the skills-based electronic game;
conducting, on the gaming system, a non-wagering session of the game of chance in the skills-based game;
determining, by the gaming system, a result of the non-wager session of the game of chance based on a certified random number generator infrastructure; and
providing, by the gaming system, an indication of the determined result of the non-wagering session of the game of chance in the skills-based game.

2. The method of claim 1, wherein the non-wagering session of the game of chance is provided as an option in a tutorial on the game of chance, the tutorial providing an explanation of the game of chance and wherein conducting the non-wagering session of the game of chance is performed in response to receiving an input indicating selection of the option.

3. The method of claim 1, wherein the certified random number generator infrastructure comprises a decentralized random number generator and wherein determining the result of the non-wagering session of the game of chance is based on a random number received by the gaming system from the decentralized random number generator.

4. The method of claim 1, wherein the result of the non-wagering session of the game of chance affects the skills-based game of chance.

5. The method of claim 1, wherein the skills-based electronic game comprises a character controlled by a player of the skills-based electronic game and wherein presenting the game of chance is performed in response to the character entering a virtual casino.

6. The method of claim 5, wherein the game of chance comprises a game conducted against other players in the virtual casino.

7. The method of claim 1, wherein presenting the game of chance is performed based on a result in the skills-based electronic game.

8. A gaming system comprising:
a processor; and
a memory coupled with and readable by the processor and storing therein a set of instructions which, when executed by the processor, causes the processor to:
execute a skills-based electronic game;
present a game of chance while executing the skills-based electronic game;
conduct a session of the game of chance in the skills-based game;
receive a random number from a decentralized random number generator of a certified random number generator infrastructure;
determine a result of the session of the game of chance based on the received random number; and
provide an indication of the determined result of the non-wagering session of the game of chance in the skills-based game.

9. The gaming system of claim 8, wherein the random number is generated by the decentralized random number generator in real-time during the session of the game of chance.

10. The gaming system of claim 8, wherein presenting the game of chance is performed based on a result in the skills-based electronic game.

11. The gaming system of claim 8, wherein conducting the session of the game of chance comprises receiving a wager on the game of chance.

12. The gaming system of claim 9, wherein the wager is made using an in-game asset of the skills-based electronic game.

13. The gaming system of claim 12, wherein the in-game asset of the skills-based electronic game comprises a loot box.

14. The gaming system of claim 8, wherein a result of the session of the game of chance comprises a result in the skills-based electronic game.

15. A non-transitory, computer-readable medium comprising a set of instructions stored therein which, when executed by a processor, causes the processor to:
execute a skills-based electronic game;
present a game of chance while executing the skills-based electronic game;
conduct a session of the game of chance in the skills-based game;
determine a result of the session of the game of chance based on random number received from a decentralized random number generator of a certified random number generator infrastructure in real time during the session of the game of chance; and
provide an indication of the determined result of the session of the game of chance in the skills-based game.

16. The non-transitory, computer-readable medium of claim 15, wherein the session of the game of chance comprises a non-wagering session.

17. The non-transitory, computer-readable medium of claim 16, wherein the non-wagering session of the game of chance is provided as an option in a tutorial on the game of chance, the tutorial providing an explanation of the game of chance and wherein conducting the non-wagering session of the game of chance is performed in response to receiving an input indicating selection of the option.

18. The non-transitory, computer-readable medium of claim 15, wherein the session of the game of chance comprises a wagering session.

19. The non-transitory, computer-readable medium of claim 18, wherein conducting the session of the game of chance comprises receiving a wager on the game of chance, wherein the wager is made using an in-game asset of the skills-based electronic game, and wherein a result of the game of chance affects the in-game asset of the skills-based electronic game.

20. The non-transitory, computer-readable medium of claim 15, wherein the game of chance comprises a casino game.
